(19) United States
(12) Patent Application Publication
(10) Pub. No.: US 2011/0247266 A1
(43) Pub. Date: Oct. 13, 2011

(54) Garden plant protector

(76) Inventor: Paul C. McMichael, Round Hill, VA (US)

(21) Appl. No.: 12/662,235

(22) Filed: Apr. 7, 2010

(51) Int. Cl. A01G 13/02

(52) U.S. Cl. 47/31.1

(57) ABSTRACT

For the protection of domestic gardens against varmints, birds, and the like, this frame screen, or multiple outdoor screens thereof, guard against invasion and are readily portable for shipping. The screen is preferably formed by stamping of a platen wherein multiple cavities are defined end-to-end and side-by-side, exposing the covered garden rows of seedlings or plants to the atmosphere, which thus exclude voracious animals from feeding on the plants. Each screen unit may be closed at ends or extended in-line to accommodate the garden rows. Alternately, the units may serve as a frame to support a flexible cover against frost, excessive wind, rain, snow and the like. For transportation, multiple frame units are fitted upon one another into a compact, moveable bundle.

The present application is based upon U.S. Provisional Application No. ______ filed Apr. 7, 2009, filed by applicant herein.

### BRIEF DESCRIPTION OF INVENTION

This defines the new Garden Plant Protector that gardeners of vegetable, herb and flower gardens require to protect garden plants, including seedlings thereof, from invasion of wildlife, such as deer, groundhogs, birds, etc. Garden Plant Protector also serves as a frame to be covered when an overnight frost becomes a threat, or as netting to repel voracious insects. This Plant Protector is offered in various sizes, viz: Large—26″×26″×72″/weight—5 pounds; Small—15″×15″×72″/weight—under 3 pounds. Six-foot long frames of the unit are conveniently stackable for shipping and storage, allowing bundles of ten or more, occupying a little more space than one. The frames are constructed of galvanized welded or fused 14-gauge wire. See annexed Welded Wire Mesh Specifications dated Apr. 6, 2010, annexed hereto as EXHIBIT A, reference C.E. Shepherd Company, 2221 Canada Dry Street, Houston, Tex. 77023.

### THE DRAWINGS

FIG. 1 is a view in Perspective of one fully assembled frame that may comprise plural end-to-end sections, end closures not being shown. The relative dimensions of the segment voids are formed by stamping of a wire platen. For rigidity, the voids are in rectangular confirmation.

FIG. 2 depicts an End View of the invention, reference the garden ground line.

FIG. 3 shows a Top View of the roof and walls depending from the roof to the ground.

FIG. 4 shows a side view of a wall of the invention.

FIG. 5 is an enlarged view of the end closure or caps in partial section.

### DESCRIPTION OF PREFERRED EMBODIMENTS

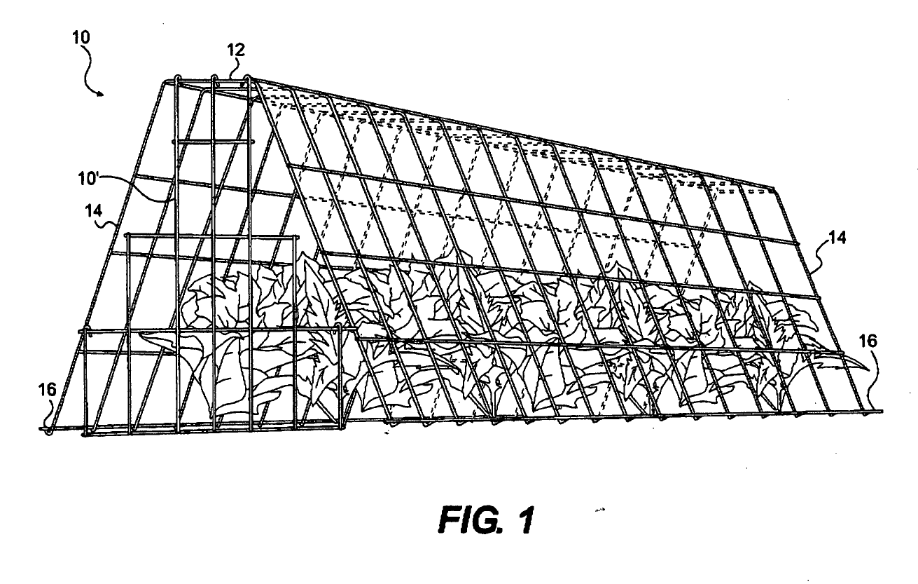

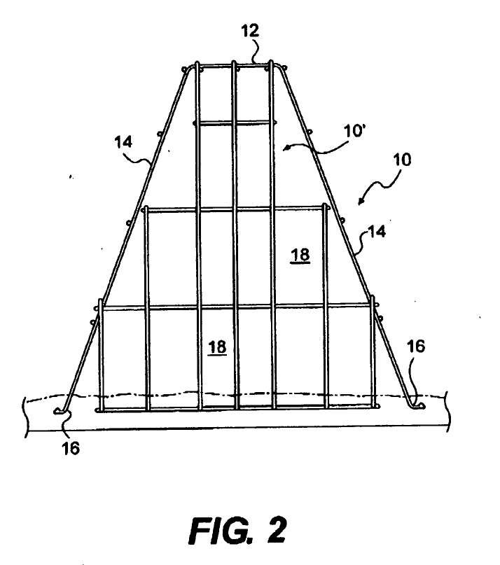

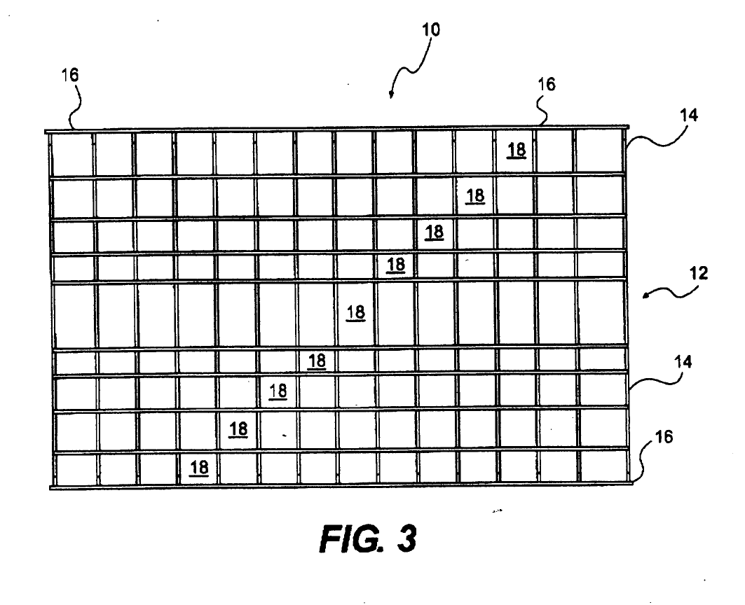

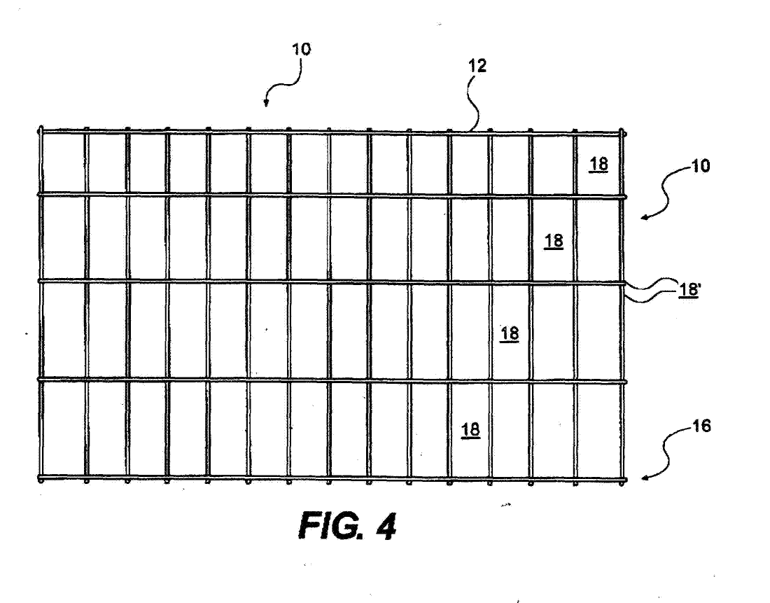

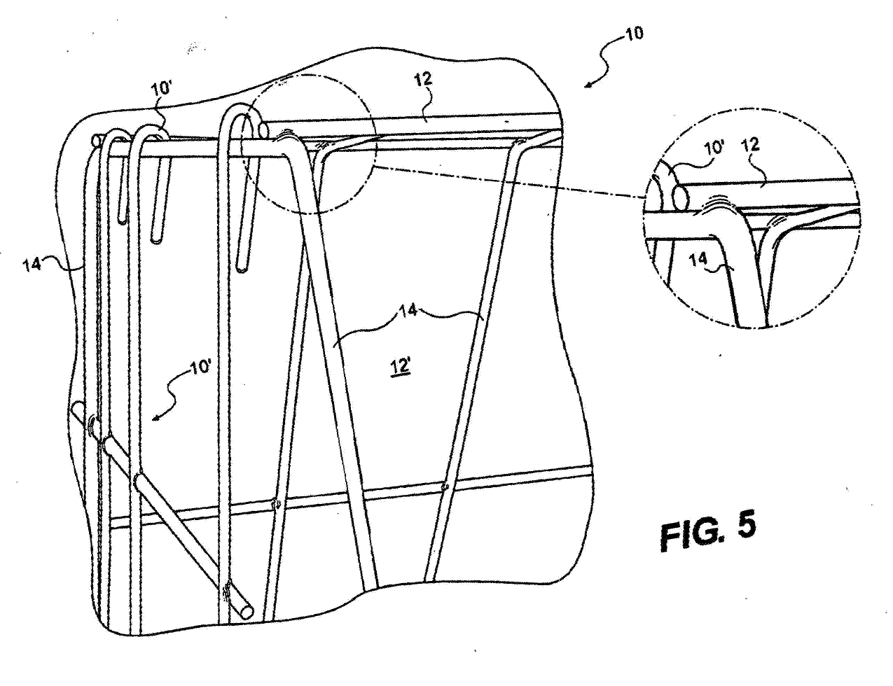

Referring to FIGS. 1, 2, 3, 4, and 5, the invention is illustrated in its broadest utility.

Galvanized metal frame 10 is initially formed by a press, prior to being defined on its exterior by segments 12, from which depend spaced apart walls 14. The roof, walls and closures 10′ are segmented to allow the free flow of atmospheric elements: wind, rain, sun to pass to and fro the frame so as to enhance growth of the seedlings into mature plants, depending upon climatic conditions. In addition, Frame sections 10 form cavities or caps at each end of the frame, defining 10′ segments therein end-to-end cavities 12′. Roof section 12 connects spaced apart walls 14. The frame itself is defined by galvanized metal wires of gauge 14. Cavity segments 12 are defined by the horizontal and vertical wires 12′ which connected in rectangular configuration define rectangular cavities that open the roof, walls and capped ends of the frame all being open the atmosphere and the elements thereof. Rigid flanges 16 extend outwardly from the walls 14 to provide garden soil anchors for the entire frame. To sustain the frame in its rigid protective function the special fused wire configuration of connected voids is preferred.

While this invention has been described in conjunction with specific embodiments thereof, it is evident that many alternatives, modifications and variations will be apparent in those skilled in the art. Accordingly, the preferred embodiments of the invention, as set forth herein, are intended to be illustrative and not limiting. Various changes may be made without departing from the spirit and scope of the intention as defined in the following claims.

1-8. (canceled)

9. An apparatus, comprising:
a rigid foraminous frame comprising a top and two side walls attached to the top;
wherein the side walls extend downward and outward away from the top and from each other and comprise bottom ends for placing on the ground to support the rigid foraminous frame;
whereby a protective coop for garden rows is formed;
wherein a plurality of the rigid foraminous frames can be stacked into a compact bundle.

10. The apparatus of claim 9, further comprising removable closures configured to close tunnel ends of the rigid foraminous frame.

11. A plurality of the apparatus of claim 9 placed end-to-end to extend the length of the protective coop formed.

12. The apparatus of claim 11, further comprising removable closures configured to close tunnel ends of the protective coop formed.

13. The apparatus of claim 9, further comprising integral outwardly-extending flanges along the bottom ends of the side walls.

14. The apparatus of claim 9, wherein the rigid foraminous frame consists of wire segments.

15. The apparatus of claim 14, wherein the wire is 14 gauge metal.

16. The apparatus of claim 14, wherein the wire segments comprise plural horizontal and plural vertical wire segments intersecting and connected at perpendicular angles to form rectangular cavities.

17. A plurality of the apparatus of claim 9 stacked into a compact bundle for shipping.

18. The apparatus of claim 9, further comprising netting secured to the rigid foraminous frame for repelling insects.

19. The apparatus of claim 9, further comprising a covering over the frame for retaining heat within the protective coop.
